(19) United States
(12) Patent Application Publication
(10) Pub. No.: US 2026/0204130 A1
(43) Pub. Date: Jul. 16, 2026

(54) System and Method for Managing Casino Gaming Yield

(71) Applicant: Tavolo Intellect LLC, Grosse Pointe, MI (US)

(72) Inventors: Ryan Patrick McClellan, Grosse Pointe, MI (US); Evan Andrew Juras, Bozeman, MT (US); Mark Bedair Wassef, Hoboken, NJ (US); Bennie Robert Mancino, London, OH (US)

(21) Appl. No.: 19/455,687

(22) Filed: Jan. 21, 2026

Related U.S. Application Data
(63) Continuation-in-part of application No. 19/449,717, filed on Jan. 15, 2026.
(60) Provisional application No. 63/747,451, filed on Jan. 21, 2025.
(60) Provisional application No. 63/745,383, filed on Jan. 15, 2025.

(51) Int. Cl. G07F 17/32; G06V 10/82; G06V 20/52

(52) U.S. Cl. CPC G07F 17/3227; G06V 10/82; G06V 20/52; G07F 17/323; G07F 17/3237; G07F 17/3241

(57) ABSTRACT

Systems and methods for managing yield at a casino gaming table. Camera derived data associated with gameplay is obtained and processed to generate inferred gameplay information representative of gaming objects, gameplay activity, or gameplay events. Inferred gameplay information is provided to one or more computing devices. Additional data associated with at least one of a casino, one or more players, or gameplay at the gaming table is obtained and analyzed with the inferred gameplay information to generate one or more outputs indicative of yield or operational performance of the gaming table. Based on the generated outputs, one or more yield-altering operational actions that modify operation of the gaming table are performed. The disclosure enables automated, data-driven management of casino gaming operations to improve yield and operational efficiency and operate as automated control systems rather than advisory tools, with human interaction limited to handling such as veto or acknowledgment inputs.

### CROSS-REFERENCE TO RELATED APPLICATIONS

This application is a continuation in part of US 19/449,717 filed on January 15, 2026, which claims the benefit of US 63/745,383 filed on January 15, 2025. This application also claims the benefit of US 63/747,451 filed on January 21, 2025. The entireties of all of these applications are hereby incorporated by reference herein for all purposes.

### FIELD

These teachings relate to casino games, and more specifically to an analytics system and method for understanding and improving yield at a casino.

### BACKGROUND

Monitoring and analyzing casino game play has become increasingly important as casinos seek to improve operational efficiency and revenue performance. Casino gaming environments typically operate with constrained, semi-fixed resources, including a finite number of gaming tables, limited floor space, and available personnel, while player participation, betting behavior, and game pace vary over time. Conventional casino operations often rely on static table configurations, betting limits, and staffing parameters that are not informed by analysis of casino operations, player behavior, and game play data. As a result, such static approaches can lead to inefficient resource utilization and suboptimal revenue performance.

Accordingly, there is a need to improve the current state in the art with respect to understanding and improving yield within a casino.

### SUMMARY

The present disclosure relates to systems and methods for managing yield at a casino gaming table using surveillance-derived inferred gameplay events.

In some embodiments, camera data associated with gameplay at a casino gaming table is obtained on a surveillance network or first network that is logically and physically isolated from a property network. The camera data generated by one or more surveillance detection devices is processed on the surveillance network by executing one or more machine-learning or deep-learning models to generate model output data representative of detected gaming objects, gameplay activity, or inferred gameplay events, without transmitting raw camera images or video frames outside the surveillance network. The model output data is then provided to an interpretation engine executing on one or more computing devices on the property network, where the interpretation engine analyzes the model output data together with additional casino-related, player-related, and/or gameplay-related data. Operation of the interpretation engine is constrained by a pre-approved rules engine that defines permissible yield-altering operational actions and applicable regulatory or operational constraints. Based on the analysis, the system outputs one or more yield-altering operational actions that are automatically implemented, subject to any required player notice and veto opportunities, or alternatively generates one or more recommendations for implementation by a casino operator.

In one aspect, camera-derived or sensor-derived data associated with gameplay at a casino gaming table is obtained from one or more detection devices, such as cameras or other sensors positioned to observe gaming activity. The camera-derived or sensor-derived data is processed by one or more processors to generate inferred gameplay information representing gaming objects, gameplay activity, or gameplay events occurring at the gaming table. The inferred gameplay information is provided to one or more computing devices configured to manage operation of the gaming table.

The computing devices further obtain additional data associated with at least one of the casino, one or more players, or gameplay at the gaming table. Such additional data may include casino-related information, player related information, or gameplay related information. Using the inferred gameplay information together with the additional data, the system generates one or more outputs indicative of yield or operational performance of the gaming table.

Casino related information or data may be or may include: operating hours, shift schedules, or staffing levels, dealer assignments, dealer break schedules, or staffing constraints, jurisdictional, regulatory, or compliance requirements, special events, promotions, tournaments, or entertainment schedules, historical or forecasted patron traffic or occupancy levels, table availability, table status (open, closed, reserved), or pit configuration economic targets, yield thresholds, or performance benchmarks, time-of-day, day-of-week, or seasonal operational parameters, or any combination thereof.

Player related information or data may include information associated with individual players or groups of players, such as: wagering behavior, bet size distributions, or betting frequency, player loyalty tier, rating, or comp information, buy-in amount, cash-out amount, or estimated bankroll, historical play duration, visit frequency, or session history, decision speed, gameplay tempo, or responsiveness, player movement, arrival, departure, or table-change behavior, player value metrics, profitability metrics, or churn likelihood, demographic or behavioral classifications derived from gameplay activity, or any combination thereof.

Game play related information or data may include information associated with the operation or state of the gaming table, such as: current or historical betting limits or wagering rules, hands per hour, game pace, or round duration, dealer performance metrics or error rates, game type, table configuration, or active player positions, gameplay anomalies, discrepancies, or interruptions, historical yield, revenue, or profit associated with the table, predicted or modeled yield under alternative operational conditions, or any combination thereof.

Additional data or information that the system and/or method may use or rely on or consider may include predicted yield or operational performance metrics, confidence scores associated with inferred gameplay information, output of machine-learning or deep-learning models, historical outcomes of prior yield-altering operational actions, feedback data used to update or retrain one or more models, stored veto reasons, override events, or exception logs, or any combination thereof.

In some embodiments, the additional data comprises any information, whether historical, real-time, inferred, predicted, or system-generated, that is relevant to analysis of yield, operational performance, regulatory compliance, or gameplay conditions at the casino gaming table.

Based on the generated outputs, the system automatically performs one or more yield-altering operational actions. A yield-altering operational action may be one or more actions that is taken by the system and/or method disclosed herein to increase yield, revenue, and/or player experience.

In some embodiments, the one or more yield-altering operational actions that modify operation of a casino gaming table and/or a set of gaming tables may include or may be selected from a group comprising one or more of: automatically increasing, decreasing, or otherwise changing a minimum betting limit and/or a maximum betting limit; changing one or more wagering rules or gaming parameters associated with a table game (including enabling, disabling, or modifying one or more side bets, bonus wagers, buy-in rules, payout rules, maximum wager rules, or table rules); automatically opening a gaming table for gameplay, closing a gaming table from further gameplay, or changing an operational status of the gaming table (including transitioning between open, closed, reserved, limited-play, or training modes); assigning, reassigning, or rotating a dealer to the gaming table or to a different gaming table; changing a dealer break schedule or staffing allocation associated with one or more gaming tables; requesting, scheduling, or dispatching casino staff (including a pit supervisor, floorman, or security personnel) to a gaming table in response to detected gameplay conditions; automatically changing a table configuration (including changing a number of active player positions, reserving one or more player positions, or designating one or more player positions as unavailable); automatically coordinating relocation of a player to a different gaming table and reserving a seat at the different gaming table; transferring or associating player rating information, loyalty information, or session information to the different gaming table; issuing, presenting, or modifying one or more player-facing notifications associated with the operational change (including displaying updated betting limits or a pending operational state on a player-facing display); and/or storing, logging, and reporting the operational change for subsequent outcome evaluation, model retraining, regulatory compliance, or auditing purposes. In some embodiments, the operational actions are executed automatically by one or more processors without requesting human approval or generating recommendations, thereby reducing latency and enabling deterministic, repeatable control of gaming table operations.

In an aspect, the camera-derived or sensor-derived data comprises camera data generated by one or more detection devices operating on a surveillance network that is logically and physically isolated from a property network at the casino. One or more machine-learning or deep-learning models are executed on the surveillance network to generate model output data representative of detected gaming objects, gameplay activity, or gameplay events. Raw camera images or video frames are not transmitted outside the surveillance network. Instead, only the model output data is transmitted to the property network, where it is combined with casino-related, player related, and gameplay related data to analyze yield and operational performance. This architecture reduces bandwidth requirements, preserves surveillance isolation, and prevents reconstruction of gameplay imagery from transmitted data.

In some embodiments, the system determines or obtains an optimal game pace for the gaming table and evaluates deviations between actual gameplay and the optimal game pace when generating the outputs. The system may further evaluate outcomes of executed yield-altering operational actions by comparing predicted yield to actual yield and may update one or more models or processors based on feedback derived from the evaluation, thereby implementing a closed-loop learning architecture that continuously improves automated decision logic.

In certain embodiments, execution of one or more yield-altering operational actions is subject to a pre-approved rules engine.

A pre-approved rules engine may be configured in advance to define permissible yield-altering operational actions that can be taken by the system and/or method disclosed herein. The pre-approved rules engine may operate as a compliance constraint, rather than as a real-time decision-making or approval component, allowing automated execution while ensuring that operational actions remain within predefined permissible bounds.

A pre-approved rules engine may be established in advance and approved by one or more of casino operations, casino management, gaming regulators, and/or a governing jurisdiction, and defines which actions are permissible, under what conditions, and with what limitations. By way of example, the pre-approved rules engine may specify allowable ranges for minimum and maximum betting limits, conditions under which a gaming table may be opened or closed, dealer reassignment constraints, notice requirements to players, veto eligibility, timing restrictions, jurisdiction-specific gaming regulations, and table- or game-specific operational parameters.

In some implementations, the pre-approved rules engine may operate as a compliance and safety constraint layer, rather than as a real-time decision-making or approval component. That is, the rules engine does not independently decide which operational action to take, nor does it require human approval at the time of execution. Instead, the rules engine constrains and bounds the yield-altering operational actions that may be automatically executed by the system, ensuring that any automatically selected action complies with pre-approved regulatory, operational, and jurisdictional requirements. If a proposed yield-altering operational action falls outside the constraints defined by the pre-approved rules engine, the action may be prevented, modified to comply with the applicable rule set, or deferred, without requesting human approval. In some embodiments, the pre-approved rules engine may be configured, updated, or audited offline or during scheduled maintenance windows, and may be selectively enabled, disabled, or customized on a per-casino, per-jurisdiction, per-game type, or per-table basis.

The preapproved rules engine may be executed via a deep learning and/or machine learning model. The preapproved rules engine may operate or be executed on any of the servers or networks disclosed herein.

In some embodiments, execution of one or more yield-altering operational actions is subject to a notice requirement, which may be mandated by one or more gaming jurisdictions, regulatory authorities, or casino policies to ensure that changes to gameplay are not implemented without player awareness. In such embodiments, the system is configured to provide advance notice of an automatic or pending operational change to one or more players prior to implementation of the change.

The notice may be presented via a player-facing display or notification device associated with the gaming table, including but not limited to a table sign, player-facing screen, electronic table display, touch-enabled panel, wearable notification device, or other visual or electronic interface visible to players participating in gameplay. The notice may indicate, for example, a pending change to a minimum or maximum betting limit, a pending table-closure state, a change in wagering rules, or another yield-altering operational action.

In some implementations, the notice is provided for a defined notice period prior to implementation of the operational change. The notice period may be jurisdiction-specific, game-specific, table-specific, or rule-specific, and may be defined by a pre-approved rules engine, regulatory requirements, or casino operational policies. By way of example, the notice period may require that a pending betting-limit change be displayed for a predetermined duration (e.g., a number of seconds, hands, rounds, or minutes) before the change is implemented.

In certain embodiments, the system provides a player acknowledgment mechanism as part of the notice, such as a selectable button, touch input, gesture input, or other interface element on the player-facing display, through which one or more players may affirm receipt, awareness, or acceptance of the pending operational change. In some jurisdictions, player acknowledgment may be required before the operational change is implemented. In other embodiments, player acknowledgment is optional and is recorded for compliance, auditing, or reporting purposes without affecting automated execution.

In some implementations, failure to receive a required acknowledgment from one or more players within the defined notice period causes the system to delay, suspend, modify, or cancel implementation of the pending yield-altering operational action. In such embodiments, the system may automatically maintain the current operational state of the gaming table until acknowledgment is received, a maximum delay threshold is reached, or an alternative operational action is selected in accordance with the pre-approved rules engine.

In some embodiments, the notice period also defines a veto window during which a veto input may be received to override the pending yield-altering operational action. The veto window may begin when the notice is first displayed and may end when the operational action is implemented or canceled. During this window, an authorized casino staff member—including but not limited to a dealer, pit boss, floor supervisor, surveillance personnel, or operations staff—may submit a veto input via an authorized device such as a pit-boss tablet, surveillance workstation, property server terminal, table computer, or dealer interface.

A veto input is accepted only if accompanied by a required reason code or explanation, which is stored as structured data. If no valid reason is provided, the veto input is rejected. In some embodiments, a veto entered by one authorized staff member may be overridden by a higher-authority staff member, such as a supervisor or manager, in accordance with predefined escalation rules. Veto data and override data may be logged and used to train or update one or more machine-learning models, decision thresholds, and/or a pre-approved rules engine, thereby improving future automated operational decisions. In addition, the system and/or method may be configured to update at least one machine-learning or deep-learning model based on measured performance outcomes of the one or more yield-altering operational actions that were implemented by the system and/or methods disclosed herewith without receiving a veto input that would otherwise override implementation of the one or more yield-altering operational actions. In this sense, the update may function as a reward that the one or more yield-altering operational actions that were implemented were acceptable to casino staff and operations, which may help boost or improve a confidence score or record of further yield-altering operational action(s) to be taken.

The notice functionality therefore operates as a technical synchronization mechanism between system execution and player awareness, enabling automated, processor-driven yield management while ensuring compliance with jurisdictional notice requirements, supporting exception handling through veto and acknowledgment mechanisms, and preserving deterministic execution of operational changes absent a valid veto or unmet notice condition.

The disclosed systems and methods therefore provide autonomous, camera- or sensor-driven yield management for casino gaming tables that maintains surveillance isolation, supports regulatory notice requirements, enables deterministic automated control, and continuously improves operational performance through outcome-based learning.

In some aspects, actual yield outcomes resulting from executed operational actions are reviewed and supplied as feedback to iteratively retrain one or more components of the system, including confidence thresholds, yield-prediction weightings, and action-selection policies.

In certain embodiments, and depending on system configuration or jurisdictional requirements, the system may additionally be configured to generate recommendations associated with improving yield or operational efficiency. Such recommendations may be presented to casino staff or gaming operations personnel for review. In other embodiments, selected actions are automatically implemented by the system without human intervention.

Advantageously, the disclosed systems and methods enable integrated analysis of casino gaming activity and support dynamic adjustment of table-game operations to improve resource utilization and yield.

In further examples, the system may generate estimates of future yield, revenue, or profit corresponding to different betting conditions, such as maintaining, increasing, or decreasing a minimum bet amount. Based on system settings and capabilities, the system may be configured to automatically implement one or more operational actions, including adjusting minimum betting limits, opening or closing one or more gaming tables or devices, reassigning dealers between tables or devices, providing incentives to one or more players, offering promotions to patrons, or combinations thereof.

In further examples, the system may generate estimates of future yield, revenue, or profit corresponding to different betting conditions, such as maintaining, increasing, or decreasing a minimum bet amount. Based on system settings and capabilities, the system is configured to automatically implement one or more operational actions, including adjusting minimum betting limits, opening or closing one or more gaming tables or devices, reassigning dealers between tables or devices, providing incentives to one or more players, offering promotions to patrons, or combinations thereof.

The analytics system and/or method disclosed herein may include machine-learning and/or deep-learning capabilities. In some examples, one or more machine-learning or deep-learning models are configured to identify and analyze visual features of playing cards, gaming chips, or similar gaming objects based on image data captured from one or more detection devices, such as overhead cameras or side-view sensors associated with a gaming table. The analysis may provide information that is conventionally collected manually by casino staff or operators. The machine-learning and/or deep-learning models may be executed on one or more computing systems or servers, including cloud-based servers, on-site servers, table-level servers or processing devices, detection-device servers, or combinations thereof. Reference is made to the teachings of commonly owned U.S. Application No. 19/449,717, filed January 15, 2026, which discloses data and information collection, analysis, and processing techniques that may be used by the systems and methods disclosed herein, the disclosure of which is incorporated by reference herein in its entirety for all purposes.

### BRIEF DESCRIPTION OF THE DRAWINGS

FIG. 1 is a schematic view of an exemplary casino gaming table configured for use with the systems and methods described herein.

FIG. 2 is a block diagram illustrating exemplary hardware components of a system described herein.

FIG. 3 is a block diagram that depicts exemplary hardware of the system disclosed herein to carry out the method disclosed herein.

### DETAILED DESCRIPTION

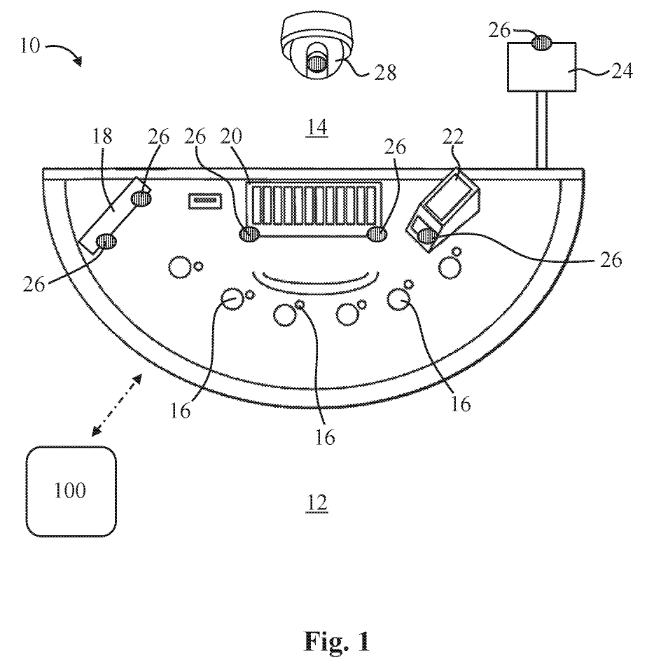

FIG. 1 illustrates a gaming table 10. The gaming table 10 may be located in a gaming facility or venue such as a casino, hotel, etc. A casino game such as blackjack, roulette, baccarat, craps, pai gow, etc., may be played at the gaming table 10. The present teachings may also be relevant to other casino gaming tables or devices for which it may be desirable to obtain or generate analytics, such as electronic gaming machines like slot machines, poker machines, keno machines, etc. In some instances, the teachings herein can be applied to connecting, transmitting, and/or processing data or information between two or more devices on different servers or networks.

Generally, the casino gaming table 10 comprises a player area 12 and a dealer area 14. The player area 12 comprises one or more betting regions 16 at which one or more players can place bets during game play.

At the dealer area 14, at which a casino dealer and/or casino staff are positioned during game play, the gaming table 10 may comprise one or more table signs 18, a chip tray 20 containing gaming chips, a card shoe 22 containing playing cards, and/or one or more elevated table or tower signs 24.

One or more sensor devices or detection devices 26 may be mounted, added, provided, integrated, and/or incorporated into, one or more elements of the gaming table 10, that are selected from a group consisting essentially of: the gaming table 10 itself, one or more table signs 18, a chip tray 20, a card shoe 22, an elevated table or tower sign 24, a discard rack, the like, or a combination thereof. A sensor device or detection device 26 may be part of a casino surveillance system (e.g., a surveillance detection device). A sensor device or detection device 26 may not be part of a casino surveillance system.

The one or more sensor or detection devices 26 may be configured to generate data or camera data. The camera data may be a video or still image of one or more gaming regions on the gaming table (e.g., betting regions, the table, felt, etc.), one or more gaming objects and/or gaming activity associated with game play at or near the casino gaming table 10 and/or body characteristics of a player, dealer, or bystander (e.g., facial recognition, hand or appendage recognition, etc.).

For example, the one or more detection devices 26 may be configured to generate camera data of gaming objects like: playing cards, gaming chips, card shufflers, discard racks, cut cards, currency, dice, loyalty cards, cashless tickets, vouchers, or coupons (e.g., TITO tickets), the like, or any combination thereof.

For example, the one or more detection devices 26 may be configured to generate camera data of activity associated with casino gaming at or near the gaming table 10 such as: a player making a buy-in or cash out; a player making various hand signals (hold, hit, etc.), a player leaving a gaming table, a player approaching a gaming table, a casino dealer dealing cards, a casino dealer collecting cards, a casino dealer making a payout, a casino dealer collecting payment, the like, or any combination thereof.

The camera data may comprise live or near-live image and/or video data captured before, during, and/or after game play at the gaming table.

The facility or venue in which the gaming table 10 is located may include one or more sensor devices or detection devices 28. The one or more detection devices 28 may form or be part of a casino surveillance system. Such detection devices 28 are typically accessible to personnel responsible for monitoring game integrity, regulatory compliance, and/or casino security and surveillance. Such detection devices may also be referred to herein as a surveillance detection devices.

A sensor detection device 28 may be located at or near a gaming table. A detection device 28 may be located or positioned above or elevated relative to the gaming table 10. A detection device 28 may be mounted to a wall, ceiling, or other structure within the facility. In some embodiments, a detection device 28 may be positioned directly overhead of the gaming table 10. In some embodiments, a detection device 28 may be at an overhead angle relative to the gaming table 10. A detection device 28 may be a camera. A detection device 28 may be an overhead camera. A detection device 28 or camera may include pan-tilt-zoom (PTZ) capabilities or may have fixed imaging characteristics.

The one or more sensor or detection devices 28 may be configured to generate camera data. The camera data may be a video or still image of one or more gaming regions on the gaming table (e.g., betting regions, the table, felt, etc.), one or more gaming objects and/or gaming activity associated with game play at or near the casino gaming table 10 and/or body characteristics of a player, dealer, or bystander (e.g., facial recognition, hand or appendage recognition, etc.).

For example, the one or more sensor o detection devices 28 may be configured to generate camera data of gaming objects like: playing cards, gaming chips, card shufflers, discard racks, cut cards, currency, dice, loyalty cards, cashless tickets, vouchers, or coupons (e.g., TITO tickets), the like, or any combination thereof.

For example, the one or more sensor or detection devices 28 may be configured to generate camera data of activity associated with casino gaming at or near the gaming table 10 such as: a player making a buy-in or cash out; a player making various hand signals (hold, hit, etc.), a player leaving a gaming table, a player approaching a gaming table, a casino dealer dealing cards, a casino dealer collecting cards, a casino dealer making a payout, a casino dealer collecting payment, the like, or any combination thereof.

The camera data from the one or more detection devices 28 may be or comprise live or near-live image and/or video data captured before, during, and/or after game play at the gaming table.

While these teachings are described with reference to understanding and improving yield at a gaming table 10, the teachings are not so limited. The teachings may also be applied to other casino gaming devices and systems for which it is useful to understand and improve yield, including electronic gaming machines such as slot machines, poker machines, keno machines, and similar devices. Accordingly, the teachings herein may be applied across various games and gaming devices or machines to understand and increase yield, revenue, and/or profit.

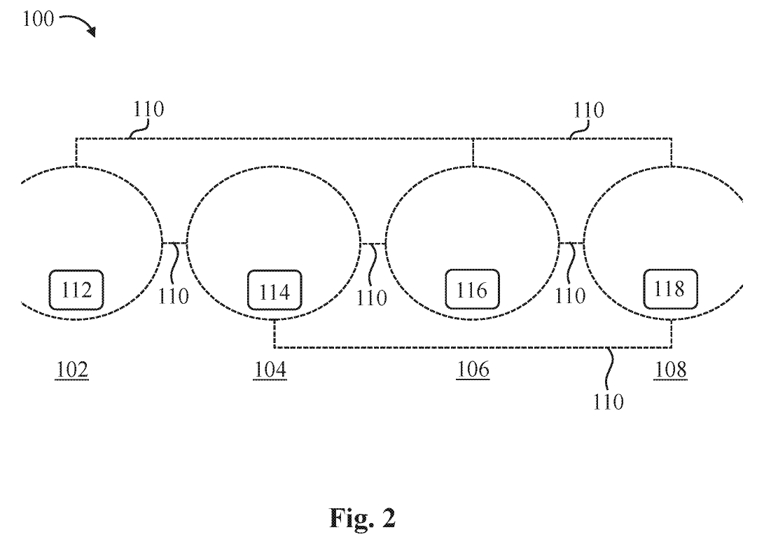

FIG. 2 is a block diagram that depicts exemplary hardware of the system 100 according to these teachings. The system 100 may be configured to manage yield and generate analytics relating to casino gaming activity at a gaming table 10 in a casino, and to execute yield-altering operational actions (automatically or as a recommendation) based on inferred gameplay information.

The system 100 and/or method described herein may comprise or utilize two or more networks. The networks may include a first network 102, a second network 104, a third network 106, a fourth network 108, and/or additional networks. Use of the terms “first,” “second,” “third,” and “fourth” network is solely for identification purposes and is not otherwise limiting with respect to order, positioning, placement, etc.

The networks 102, 104, 106, 108 may be a cloud network, a surveillance network, a property network or site network or on-site network, and a table network. In some instances, the system 100 may include two networks (e.g., a surveillance network and a property network, or a surveillance network and a table network, or a cloud network and a surveillance network, or a cloud network and a property network, or a cloud network and a table network, or a property network and a table network ). In some instances, the system 100 may include three networks. In some instances, the system 100 may include the four networks. It is to be understood that two or more of the networks described herein may be combined into a single network, a network may be omitted, duplicated, etc.

The networks may be separate and distinct networks. The networks may be electrically connected together via one or more communication protocols to allow for data, signal, and/or information transfer between the networks and/or processors, servers, computers, etc. in the networks. A network may comprise a communication infrastructure, interface, or link 110 that functions or enables information, data, and/or signals to move or be transmitted between the networks and/or two or more servers or computing devices on different networks. The communication infrastructure, interface, or link between the networks may be unidirectional (single direction) or bidirectional. The communication infrastructure, interface, or link between the networks may be a wired or wireless device.

A cloud network may be a network that is located offsite or remote or in a different location from the physical venue or facility in which the gaming table is located.

A surveillance network may be located at the casino venue or facility, or in some instances, may be a remote or cloud network located offsite or remove from the casino venue. A surveillance network may be a restricted or “black box” network. A surveillance network may be hidden or isolated and accessible only to authorized individuals and/or authorized devices having appropriate credentials associated with, for example, casino management, operations, compliance, and/or surveillance. Typically, one or more surveillance detection devices 28, such as cameras used for casino security and game integrity, are located on the surveillance network. Typically, only individuals, staff and/or devices associated with casino security and/or surveillance are provided with camera data or output streams (e.g., still images and/or video camera feed) from the detection devices 28 on the surveillance network. This restriction on access to the surveillance network and/or the associated detection devices 28 and/or the associated camera data from the surveillance detection devices 28 may help reduce or prevent unauthorized access to information or detection devices 28 that may give certain casino patrons or players an advantage at the table game. Such an advantage might mean advantage play as a result of card counting. If the count is in a player’s favor, thus the odds are better for the player, a player may sit down at the table and wager more with a higher win percentage.

A property network or site network or on-site network, which may be used interchangeably unless otherwise noted, may be a network that is located on site at the casino facility. A property network may be or may comprise a local network located at a casino facility. A property network may be a local network at the casino facility used for communicating information to/from/between one or more casino devices used for casino operations and/or game play. For example, one or more casino devices on the property network may be or may include one or more computers, laptops, tablets, printers, gaming tables, slot machines, TITO machines (ticket-in-ticket-out), detection devices, automated teller machines (ATM’s), table computer or processors, analysis servers, televisions, and the like. A property network may be a separate network from the cloud network, surveillance network, and/or table network.

In some embodiments, a property network does not include direct access to the internet. However, some property networks may include internet access, possibly via a gateway or other controlled interface. A property network is typically not accessible by the general public and/or patrons of the casino. In some jurisdictions, a casino surveillance and/or management team may have access to the property network. In some configurations, the property network may provide a communication interface or protocol for communicating or facilitating data communication between one or more devices on the surveillance network, one or more devices on the property network, and/or one or more devices on the cloud network. For example, the property network may enable one-way or two-way communication between an overhead detection server and a property server. The property network may enable one-way or two-way communication between a cloud server and a property server. The property network and/or property server may provide for 1 or 2-way communication between the cloud network and the surveillance network and the respective servers contained therein.

A table network may be an edge network that is located at or nearby a gaming table. A table network may be separate and distinct from the surveillance network, property network, cloud network, etc. A table network may provide for local processing at the table. A table network may reduce latency due to its location at the table.

The system 100 and/or method described herein may comprise or utilize two or more servers. A server may be, or may comprise, one or more computing devices, processing devices, software instances, interpretation engines, machine learning models or techniques, deep learning models or techniques, etc. A server may perform processing, storage, or computing services (e.g., running models, storing data, generating analytics). A server may be a computing device. A server or computing device may comprise a processing device such as a Neural Processing Unit (NPU), graphics processing unit (GPU), or other accelerator suitable for deep learning and/or machine learning model execution.

A server may comprise a non-transitory computer-readable medium storing instructions is disclosed that, when executed by one or more computing devices, cause the one or more computing devices to perform the method disclosed herein, including automatic execution of yield-altering operational action.

The servers may comprise a first server 112, a second server 114 a third server 116, and a fourth server 118. It is understood that use of terms ‘first’, ‘second’, ‘third’, and ‘fourth’ server is strictly to refer to the different servers and is not otherwise limiting with respect to order, positioning, placement, etc. The servers may comprise a cloud server, an overhead detection server, a property server, and a table computer or processor. It is to be understood that one or more of the servers described herein may be combined into a single server, omitted, duplicated, or otherwise rearranged. It is noted that property server, site server, and on-site server may be used interchangeably unless otherwise noted.

A cloud server may refer to a server located remote from a casino facility. A cloud server may be located in or executed on a cloud network. A cloud server may be located in a facility, region, or geographic location that is separate from the casino or gaming venue. In some configurations, the cloud server may be accessible from within the casino facility via the cloud network that is in electronic communication with one or more other servers or networks, including the property network, the property server, the surveillance network, the surveillance server or overhead detection server, the table computer or processor, the table network, or any combination thereof.

An overhead detection server may be a server that is located in or executed on the surveillance network. An overhead detection server may be a server that is located on site at the casino facility and typically accessible only to security personnel of the casino.

A property server may be a server that is located on site at the casino facility. A property server may be located in or executed on the property network. A premise sever may be a server that is located on site at the casino facility and typically accessible only to casino management, staff, operations, and/or surveillance of the casino.

A table computer or processor may be an edge computer or processor that is located at or nearby a gaming table. A table computer or processor may be located at or executed in a table network. A table computer or processor may be an edge computer or processor. In some instances, a table computer or processor may be a server or utilize components of a server. A table computer or processor may be located at or near a gaming table and may control one or more player-facing displays, table signage, or dealer interfaces used to present operational changes such as betting-limit changes.

The system 100 and/or method described herein may comprise or utilize one or more models. A model may be or may comprise an electronic representation, depiction, or template of a casino gaming table and/or one or more gaming elements used at the gaming table or associated with casino gameplay, including gaming elements present on or used in connection with a gaming table before, during, and/or after gameplay.

A model may be or may comprise an electronic representation of one or more of elements selected from a group comprising or consisting essentially of: playing cards, playing card values, playing card suits, gaming chips, gaming chip values or denominations, chip stack heights, currency values, the gaming table, the felt or layout design that is located or printed on the table, one or more betting regions on the felt or gaming table, one or more table signs, a chip tray, a card shoe, one or more cut cards, discard rack, loyalty cards, cashless tickets or coupons e.g, TITO tickets, the like, or a combination thereof. A model may include an electronic depiction or representation of dealer and/or player and/or movements or gestures made by a player or dealer, such as a dealer making a payout or collecting chips or currency, or a player making a gesture to hit, stand, or fold.

A model may include or may be built using machine learning and/or deep learning techniques. A model may comprise machine learning and/or deep learning techniques.

A model may be executed on any of the networks disclosed herein (e.g., the cloud network, surveillance network, property network and/or table network). A model may be executed using one or more hardware accelerators comprising or selected from the group consisting of Graphics Processing Units (GPUs), Tensor Processing Unit (TPUs), and Field-Programmable Gate Arrays (FPGAs).

The system 100 and/or method described herein may comprise or utilize one or more computing devices. A computing device may be configured to process model output data to infer, determine, deduce, conclude, speculate, or hypothesize gaming events or performance metrics and generate the analytics relating to the casino gaming activity.

A computing device may be located on, reside on, or executed on or by one or more of the servers and/or networks described herein. A computing device may comprise one or more software, algorithms, look-up tables, machine learning and/or deep learning techniques. A computing device may be configured to interpret the model output data to infer higher-level game events and performance metrics to determine events and/or activity such as a gaming event or round has started or ended, bet wager amounts or information, hands per hour, player betting behavior, etc., thereby generating analytics related to the casino gaming activity taking place or has taken place.

For instance, if model output data indicates that one or more gaming chips have been placed in a particular wager position and that one or more playing cards are subsequently detected near that wagering position, a computing device can determine or infer that a round of game play has started. Conversely, if the model output data indicates that all playing cards have been removed from the gaming table, the computing device may determine or infer that the round of gameplay has ended. Such analysis that are inferred by the one or more computing devices can be output or transmitted to authorized personnel or systems, such as casino operations, management, security, or other designated recipients.

Generally, as an overview, during operation, one or more detection devices (e.g., detection device 26 and/or 28) may observe gaming elements and/or gaming activity at a gaming table. The one or more detection devices may generate camera data (e.g., still and/or motion video and/or images). The camera data may be provided as, inputted to, supplied, or ran in or through at least one model executed by or on one or more servers or computing devices on the one or more networks to generate model output data. In some implementations, the model may reside on the same network or server that the one or more detection devices are on. In some implementations, the camera data, the model, the model output data, are all processed on the same network, computer, computing device, or a combination thereof. In some implementations, the model may reside on a different network or server that the one or more detection devices are on. In such a case, the camera output data must be sent, transmitted, or provided to the network on which the model resides or is executed on. The model output data may be an electronic representative of the content of the camera data. Once generated, the model output data may be processed by one or more computing devices or interpretation engine to infer, determine, deduce, conclude, speculate, or hypothesize certain gaming events or performance metrics and generate the analytics relating to the casino gaming activity. The model output data may be transferred, output, sent, or provided to another network and server, and subsequently processed by one or more computing devices or interpretation engine to infer, determine, deduce, conclude, speculate, or hypothesize certain gaming events or performance metrics and generate the analytics relating to the casino gaming activity. The model output data may be processed by one or more computing devices or interpretation engine on the same network on which the model output data is generated.

For example, the camera data may include an image or video of a playing card, a gaming chip, and currency. The camera data may be analyzed or run through at least one model executed by or on one or more servers or computing devices on one or more networks to generate model output data. The model output data may include a determination that the playing card is a queen of hearts, the gaming chip has a value of $5.00, and the currency is a United States dollar having a value of $50.00. The model output data may be transferred, output, sent, or provided to another network and server, and subsequently processed by one or more computing devices or interpretation engines to infer, determine, deduce, conclude, speculate, or hypothesize for example, a winning hand, a losing hand, a payout, a buy in, a game beginning, a game ending, etc. The resulting analytics may be provided to casino staff, operations, management, etc. for further analysis, processing, and/or reporting purposes.

For example, the camera data may include an image or video of an individual making a hand gesture. The camera data may be analyzed or run through at least one model executed on a network to output model output data. The model output data may include a determination that the hand gesture is a player communicating a hand signal to the dealer requesting to “hit.” The model output data may be transferred, output, sent, or provided to another network and server, and subsequently processed by one or more computing devices or interpretation engine to infer, determine, deduce, conclude, speculate, or hypothesize for example, a winning hand, a losing hand, a payout, a buy in, a game beginning, a game ending, etc. The resulting analytics may be provided to casino staff, operations, management, etc. for further analysis, processing, and/or reporting purposes. The analytics may be provided to a software or database system such as a player rating system for storage and/or further analysis. In some configurations, additionally or alternatively, the model output data may be provided to the player rating system and/or casino staff or operations for storage and/or further analysis and/or reporting.

The supply, transfer, and/or transmission of camera data to the one or more models, servers, or computing devices may be in real time or near real time, or the camera data may be intentionally delayed (e.g., a time lag) by a predetermined time interval to reduce risk that camera data being intercepted and/or used for unauthorized purposes, such as advantage play within the casino.

The supply, transfer, and/or transmission of model output data to the one or more servers, processors, computing devices, interpretation engines, etc. may be in real-time or in near real time, or may be intentionally delayed (e.g., a time lag) by a predetermined time interval to reduce the risk that image data or video data could be intercepted and used for unauthorized purposes, such as advantage play within the casino.

In some implementations, the model output data may be maintained or kept on the same network or server, and processed by one or more computing devices or interpretation engines on the same server or network to infer, determine, deduce, conclude, speculate, or hypothesize for example, a winning hand, a losing hand, a payout, a buy in, a game beginning, a game ending, etc.

Based on analysis of the inferred gameplay information, the system may automatically execute one or more yield-altering operational actions, such as any of the actions disclosed herein, like adjusting betting limits or closing a gaming table. In some embodiments, the system provides advance notice of the operational change on a player-facing display associated with the gaming table. A veto input may be received from an authorized device to override the pending change, and a reason for the veto may be recorded and used as feedback to train or update system logic. Absent a veto, the operational change is automatically implemented without requesting human approval.

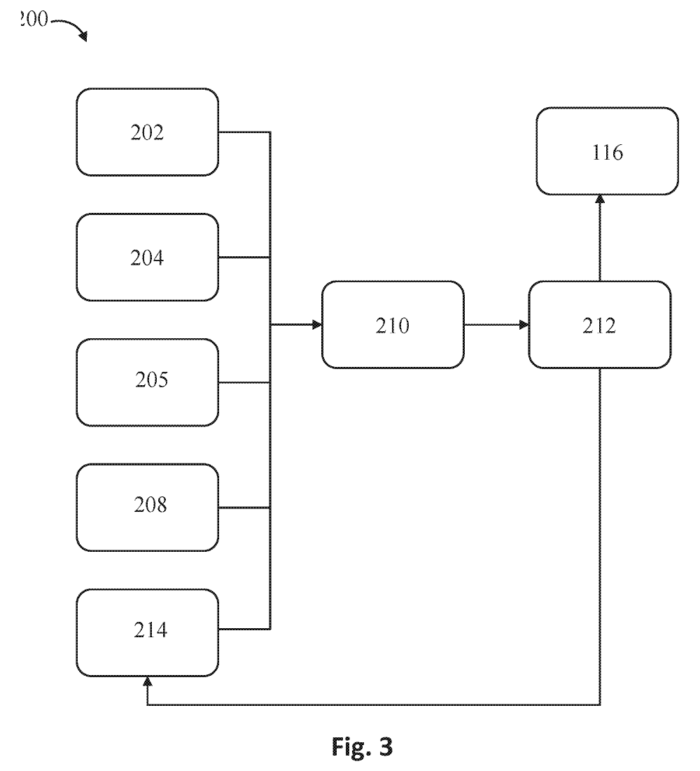

FIG. 3 is a block diagram depicting exemplary hardware of the system 100 and exemplary steps for carrying out the method 200 described herein. The system and method 200 may be configured to collect, obtain, and analyze data or information associated with casino gaming activity to determine, evaluate, and/or manage casino yield. The system may automatically perform one or more yield-altering operational actions that modify operation of a gaming table based on inferred gameplay information and additional data.

The method 200 disclosed herein includes a plurality of steps. It is understood that two or more of the steps disclosed herein can be combined into a single step; one or more steps can be duplicated; one or more steps can be eliminated; the order of the steps can be changed; one or more steps can be split up into two or more steps; or any combination thereof.

The method 200 includes a step 202 of obtaining information or data associated with a casino or other gaming venue. For example, the information or data about the casino may include the total number of gaming tables or gaming devices at the casino or venue; the number of gaming tables or gaming devices that are currently open and available for gameplay; the number of gaming tables or gaming devices that are currently closed and not available for gameplay; the current day of the week and/or time of day; operating hours of the casino (e.g., the hours of operation of the casino or number of hours per day that the casino is open for business; the number of days per week that the casino is open for business; the days that the casino is closed for business due to holidays, for example; the work schedule of one or more casino employees such as the one or more table games dealer; the number of breaks the table games dealer is permitted to take per shift; any special events that may be taking place at the casino such as a concert, sporting event or entertainment show; average or forecasted patron traffic per day (e.g., average or predicted number of customers per day); or any combination thereof.

The information for step 202 can be obtained from known casino operations, calendars, or schedules; one or more of the detection devices 26, 28; or a combination thereof. The information or data in step 202 can be collected by the one or more data collection modules and/or sent to the one or more servers, networks, or processors. The one or more data collection modules may comprise one or more servers, computers, memory, processors, software, algorithms, networks, or a combination thereof. The one or more data collection modules may be located on site at the casino or venue (e.g., premise or site network or server and/or at the table level server or network and/or in the cloud or cloud server.

The method 200 includes a step 204 of obtaining, with one or more data collection modules, information or data about one or more players playing at a gaming table or gaming device (e.g., “player data”). The player data obtained in step 204 may include information or data related to one or more players playing one or more table games or gaming devices at the casino. The player data may refer to the minimum, maximum, or average main wager, side wager, or both of one or more players. The player data may include the player’s loyalty tier at the casino or gaming venue. The player data may be obtained from or include any ratings that the player is associated with in one or more player rating systems. The player data may include information about where a player resides related to bankroll based on when the player bought in, how much the player bought in for, and if the player’s current estimated bankroll is higher or lower than the players estimated bank roll. The player data may include data concerning the player's skill level. The player data may include data or information about the player's decision speed based on how quickly the dealer moves past the player after a decision is made. The player data may include the player’s visit frequency to the casino or gaming table, gaming habits, or both. The player data may include the player’s arrival time, current play time, average historical play duration, and/or current bankroll to determine the estimated duration the player may continue to play. The information or data in step 204 can be collected by the one or more data collection modules, sent to the one or more data collection modules from the one or more detection devices or other information sources, and/or can be pushed to the one or more data collection modules from the one or more sources or detection devices. The one or more data collection modules may comprise one or more computers, memory, processors, software, algorithms, networks, or a combination thereof. The one or more data collection modules may be located on site at the casino or venue (e.g., in the building or at the table level), and/or located in the cloud. The one or more data collection modules associated with step 204 may be the same as the module(s) associated with step 204 or a different module(s). In some embodiments, player related data is obtained from a player rating system, loyalty system, or other casino system, and/or inferred from sensor-derived data associated with gameplay at the gaming table.

The method 100 includes a step 206 of obtaining, with one or more data collection modules, information or data about game play at the table game at the casino. The data obtained may include data concerning the current minimum betting limit and how long that particular betting limit has been in operation for. The data obtained may include a determination or observation if the players playing at the table game are playing at or above the minimum or maximum table limit. The data obtained may include the number of hands the dealer deals per hour, the speed of the dealing, and or a history of the dealing and whether or not there have been observed errors and or gameplay discrepancies. The data obtained may include dealer hands per hour, dealer hands per shift, and or dealer hands per day, etc. The information or data in step 206 can be collected by the one or more data collection modules, sent to the one or more data collection modules from the one or more detection devices or other information sources, and/or can be pushed to the one or more data collection modules from the one or more sources or detection devices. The one or more data collection modules may comprise one or more computers, memory, processors, software, algorithms, networks, or a combination thereof. The one or more data collection modules may be located on site at the casino or venue (e.g., in the building or at the table level), and/or located in the cloud. The one or more data collection modules associated with step 206 may be the same as the module(s) associated with step 202/204 or a different module(s). In some embodiments, at least a portion of the gameplay-related data comprises sensor-derived data and/or inferred gameplay information generated by processing sensor-derived data.

The method 200 includes a step 208 of calculating an optimal game pace at the table game based on a number of players playing at the table game, or obtaining the optimal game pace at the table game from a stored database. The calculating step 208 may take place with a calculator or processor that includes a software or algorithm for calculating the optimal game pace at the table game based on a number of players playing at the table game. Additionally, or alternatively, the optimal game pace at the table may be obtained from historic data or a look-up table or memory. In some embodiments, the optimal game pace is determined for a particular game type, table configuration, dealer, time period, and/or jurisdiction.

The method 200 includes a step 210 of analyzing with an algorithm, machine learning, deep learning, computer, processor, software: i) the obtained data about the casino from step 202; ii) the obtained data about the one or more players from step 204, iii) the obtained data about the table game from step 206; and/or iv) the calculated or obtained optimal game pace at the table game from step 208 to obtain one or more outputs. In this step 210, the data or inputs from one or more of the data or information collection steps 202, 204, 206, 208 is analyzed and interpreted. In some configurations, certain inputs from steps 202, 204, 206, 208 may be weighed more heavily than other inputs during the analysis to obtain the output. In some configurations, certain inputs from steps 202, 204, 206, 208 may be disregarded. In some configurations, all inputs from steps 202, 204, 206, 208 may be used to obtain the output. As discussed further below, an input 214 is also considered in the analysis step 210. The input 214 may be a review input that is obtained after step 212 discussed below. This review input 214 may be a post mortem that occurs after step 212, which analysis the effectiveness of step 212. In some embodiments, the one or more outputs are indicative of yield or operational performance of the gaming table and are generated by analyzing inferred gameplay information together with the additional data.

In response to the one or more outputs generated in step 210, the method 200 includes a step 212 of performing one or more actions, including one or more of the following: (i) providing, to casino staff or operators, an estimate of current and/or future revenue, profit, or yield for a table game based on current gaming conditions or gameplay; (ii) automatically changing a betting limit for a table game, including increasing or decreasing a minimum and/or maximum betting limit; (iii) determining an optimal number of players for a table game; (iv) determining which of the one or more players are wagering above a minimum betting limit; (v) determining which of the one or more players is most valuable to the casino or gaming venue; and/or (vi) selecting one or more table games that are expected to benefit from a betting-limit adjustment and, in response: (a) automatically increasing or decreasing a betting limit at the selected one or more table games; and/or (b) generating and transmitting a recommendation to a display device (for example, a rear-facing table sign, a tablet, or a computing device managed by a pit manager or casino supervisor) to increase, decrease, or maintain a betting limit, to close or open one or more table games, and/or to move or assign a dealer to a different table game. Any combination of the actions (i)–(vi) may be performed.

In some embodiments consistent with the claims, step 212 includes automatically performing one or more yield-altering operational actions that modify operation of the gaming table without requesting human approval or generating a recommendation. In some embodiments, the yield-altering operational actions comprise any of the actions disclosed herein including but not limited to automatically increasing or decreasing a minimum betting limit at the gaming table and/or closing the gaming table from further gameplay. In some embodiments, the yield-altering operational actions comprise assigning or reassigning a dealer to the gaming table or a different gaming table. In some embodiments, prior to implementing a pending operational change, the system provides notice of the pending operational change to one or more players via a player-facing display or screen associated with the gaming table, including displaying the pending betting-limit change and/or a pending table-closure state on the player-facing display.

As discussed above, after one or more actions are performed or recommendations are provided in step 212 in response to the output of step 210, the method 200 includes a step 214 of reviewing the action performed or the recommendation provided. During step 214, an effectiveness of the action or recommendation may be evaluated or analyzed. In some embodiments, step 214 includes evaluating an outcome of an executed yield-altering operational action by comparing a predicted yield to an actual yield after the operational action is implemented.

For example, if the action or recommendation from step 212 was to raise the minimum bet limit to increase revenue or yield by a certain percentage or amount, the step 214 will review the actual outcome to determine if the revenue or yield was actually increased by the predicted amount. In some embodiments, the predicted yield is determined in step 210 and the actual yield is measured after implementation of the operational action in step 212.

If the actual increase in the revenue or yield was in line with the predicted revenue or yield, then the system will be rewarded so that during the next analysis step 210, the system will make its prediction, recommendation, or action with a greater degree of confidence. This reward system is used as a machine or deep learning system to continue to train the analysis step 210 to take certain inputs 202, 204, 206, 208214 into greater or lower consideration. On the other hand, if the recommended change resulted in a lower yield than predicted during the review step 214, then the next recommendation or action taken by step 212 may adjust the recommendation or action to not make the same mistake again. The goal of the input 214 is to train the deep learning or machine learning model over time so that the degree of accuracy continues to increase. In some embodiments consistent with the claims, one or more machine-learning or deep-learning models used in the analysis step 210 are updated based on feedback derived from the evaluated outcome in step 214. In some embodiments, the feedback is used to retrain or adjust confidence thresholds, yield-prediction weightings, and/or action-selection policies.

The method 200 may also include a step 216 of providing a summary of the action or recommendation taken in step 212. This step 216 may be provided on predetermined basis (e.g., hourly, after every shift, daily, weekly, monthly, quarterly, annually, etc.). This report from step 26 may provide information about any yield change (increase, decrease, or stay the same) as a result of following the recommendation or action taken in step 212 or not following the recommendation or action suggested in step 212. This will allow casino operators and management to appreciate the value that the system and method disclosed herein provide. In some embodiments, the summary includes a per-table record of implemented operational actions, predicted yield, actual yield, and yield variance. In some embodiments, the system displays at least a portion of the yield change and/or the operational change status on a display device, including a player-facing display and/or an operator display.

For example, the report or summary generated in step 216 may include comparative analyses of yield across different time periods, such as comparing yield from a previous day, shift, or defined interval to a current day, shift, or defined interval. The summary may further include analyses of yield on a per-table and/or per-dealer basis, analyses comparing yield before and after an action or recommendation was implemented, and analyses indicating yield differences associated with actions or recommendations that were implemented or not implemented.

In some configurations, if the system and method according to these teachings recommends or automatically applies a bet limit change, specifically an increase in the minimum bet, then some players may not desire to continue playing at the new increased bet limit; however, the player may wish to still play but lower limit. In such a situation, player may request that the dealer, using a touchscreen keypad, or a supervisor, using the rear screen of a sign or a mobile tablet, reserve a seat for the player at a different table to relocate the player. If the system or casino utilizes a rating system, the player relocation information may be presented at the new table with a pending reservation. The pending reservation may show up on the dealer screen or a rear screen or a sign at the new table, or the dealer may be alerted of the relation reservation or via a tablet used by a supervisor. The dealer, supervisor, or staff may place a reserved puck on the reserved position at the new gaming table. The system or the dealer touchscreen may then indicate the relocation reservation is pending, as might the rear screen of the sign or pit Tablet. Upon arriving at the new table, the rating for the relocated player may be transferred to the new table. In the instance of facial recognition, the relocating player’s information may initially be stored in the system and after the relocated player arrives at the new table, the reservation will show arrived and the reservation is removed. The player can then continue game play at the previous or a lower bet limit at the new gaming table. In some embodiments, prior to implementing a pending bet-limit increase, the system provides notice on a player-facing display at the gaming table indicating the pending change, and the system permits a veto input to override the pending change as an exception-handling mechanism. In some embodiments, the veto input requires entry of a reason for the veto, and the entered reason is stored and used as feedback to train or update one or more processors or models used to generate subsequent automated operational changes.

In some configurations, if the system and method according to these teachings recommends or automatically applies a bet limit change, specifically an increase in the minimum bet, then some players may not desire to continue playing at the new increased bet limit; however, the player may wish to still play but lower limit. In such a situation, player may request that the dealer, using a touchscreen keypad, or a supervisor, using the rear screen of a sign or a mobile tablet, reserve a seat for the player at a different table to relocate the player. If the system or casino utilizes a rating system, the player relocation information may be presented at the new table with a pending reservation. The pending reservation may show up on the dealer screen or a rear screen or a sign at the new table, or the dealer may be alerted of the relation reservation or via a tablet used by a supervisor. The dealer, supervisor, or staff may place a reserved puck on the reserved position at the new gaming table. The system or the dealer touchscreen may then indicate the relocation reservation is pending, as might the rear screen of the sign or pit Tablet. Upon arriving at the new table, the rating for the relocated player may be transferred to the new table. In the instance of facial recognition, the relocating player’s information may initially be stored in the system and after the relocated player arrives at the new table, the reservation will show arrived and the reservation is removed. The player can then continue game play at the previous or a lower bet limit at the new gaming table. In some embodiments, prior to implementing a pending bet-limit increase, the system provides notice on a player-facing display at the gaming table indicating the pending change, and the system permits a veto input to override the pending change as an exception-handling mechanism. In some embodiments, the veto input requires entry of a reason for the veto, and the entered reason is stored and used as feedback to train or update one or more processors or models used to generate subsequent automated operational changes.

In one example, a method for understanding and improving yield at a casino is disclosed. The method comprising: obtaining data with a data collection module about the casino, wherein the data comprises open hours per table; dealer schedules; obtaining data with a data collection module about one or more players playing a casino game at a table game at the casino; obtaining data with the data collection module (or another data collection module) about game play at the table game at the casino; calculating an optimal game pace at the table game based on a number of players playing at the table game and elapsed time, or obtaining the optimal game pace at the table game from a stored database; obtaining an output by analyzing with an algorithm, machine learning, or deep learning in response to the following being provided or obtained: i) the obtained data about the casino; ii) the obtained data about the one or more players; iii) the obtained data about the table game; iv) the calculated or obtained optimal game pace at the table game; and in response to the output, the method is configured to: i) provide an estimate of current or future revenue, profits, or yield at the table game based on current gaming conditions or game play; ii) automatically change (increase or decrease) a betting limit on the table games; iii) determine an optimal level of players for the table game; iv) determine which players of the one or more players are betting higher than a minimum; v) determine which of the one or more players is the most valuable to the casino; vi) choose one or more tables that will benefit from a limit increase or a limit decrease and then: a) automatically increase or decreasing the limit at the one or more tables; or b) send a recommendation to a rear screen of a tablet sign or a table managed by a pit manager or casino supervisor to increase, decrease, or maintain the minimum bet limit; close one or more tables; open one or more tables; and/or move or assign a dealer to a different gaming table; or viii) any combination of i)-vi). In some embodiments, the method automatically performs the betting-limit change without requesting human approval or generating a recommendation.

The method disclosed herein may operate continuously to continue to provide casino operators or management with real-time yield data and/or to recommend or automatically change gaming rules at the casino. In other configurations, the method may be executed periodically, such as once or multiple times per hour, per shift, per day, or at other defined intervals.

The method disclosed herein may optionally employ one or more machine-learning and/or deep-learning techniques to refine analysis, predictions, recommendations, and/or automated responses generated by the system in response to one or more outputs. In some embodiments, sensor-derived data is processed to generate inferred gameplay information representative of gaming objects, gameplay activity, or gameplay events, and the inferred gameplay information is used as an input to the analysis step 210.

The method disclosed herein may optionally employ one or more machine-learning and/or deep-learning techniques to refine analysis, predictions, recommendations, and/or automated responses generated by the system in response to one or more outputs.

In some configurations, the system disclosed herein comprises one or more computing devices configured to implement and execute the methods and steps described above. The one or more computing devices may include one or more processors or controllers operatively coupled to one or more memory devices. The processors may comprise general-purpose processors, microprocessors, microcontrollers, application-specific integrated circuits (ASICs), field-programmable gate arrays (FPGAs), digital signal processors, or combinations thereof. The memory devices may comprise one or more non-transitory computer-readable storage media, such as volatile memory, non-volatile memory, or a combination thereof, and may store software instructions, algorithms, data structures, models, parameters, and historical data used to perform the disclosed operations.

he memory may store program instructions that, when executed by the one or more processors, cause the system to obtain, receive, and process data associated with casino operations, players, gameplay, and table conditions, as described with respect to steps 202, 204, and 206. The memory may further store data structures, look-up tables, historical datasets, and/or trained models used to determine or obtain optimal game pace information, as described with respect to step 208. In some configurations, the memory stores executable instructions implementing one or more algorithms for data aggregation, normalization, filtering, weighting, and analysis. In some embodiments, execution of yield-altering operational actions is subject to a pre-approved rules engine configured in advance to define permissible operational changes and constraints under which the operational actions may be executed, the rules engine operating as a compliance constraint rather than as a real-time decision-making or approval component. In some embodiments, camera data is analyzed on a surveillance network that is isolated from a property network to generate model output data, and only the model output data is transmitted to the property network without transmitting raw camera images or video frames outside the surveillance network.

The processors may execute one or more algorithms, including rule-based logic, statistical models, optimization routines, and/or machine-learning or deep-learning models, to analyze the obtained data and generate outputs as described with respect to step 210. Such algorithms may be configured to operate using all available inputs or selected subsets of inputs, to apply different weights to different inputs, and to update internal parameters based on feedback data obtained during review operations, such as those described with respect to step 214. In this manner, the system may iteratively refine predictions, recommendations, or automated actions over time.

In some configurations, the system further includes one or more communication interfaces configured to exchange data with external devices or systems, such as detection devices, cameras, player tracking systems, casino management systems, dealer interfaces, table signage, supervisor tablets, and/or cloud-based services. The communication interfaces may support wired and/or wireless communication protocols and may enable real-time, near real-time, or batch data transfer.

The processors may be further configured to generate control signals, commands, or recommendations based on the outputs of the analysis, and to automatically implement one or more actions or to present recommendations to casino personnel, as described with respect to step 212. The system may additionally generate summaries, reports, or dashboards, as described with respect to step 216, using reporting or visualization software stored in memory and executed by the processors.

The components of the system may be co-located at a casino or gaming venue, distributed across multiple on-site devices, and/or partially or fully implemented in a remote or cloud-based computing environment. In some configurations, different steps of the method are executed by different processors or computing nodes, while in other configurations multiple steps are executed by a single integrated computing platform.

It is understood that the method steps can be performed in virtually any order. Moreover, one or more of the following method steps can be combined with other steps; can be omitted or eliminated; can be repeated; and/or can separated into individual or additional steps.

As used herein, a server may comprise one or more computers, processors, and/or processing devices. A server may be configured to compute, process, determine, exchange, compare, and/or share information, data, and/or computing resources with other components or clients of the system. A server may include one or more processors and one or more memories, such as hard drives, random access memory (RAM), or other non-transitory computer-readable storage media, for storing data, executing program instructions, and performing analysis and interpretation of data.

A server may store and execute software, firmware, algorithms, rules, lookup tables, interpretation engines, machine learning models, deep learning models, or combinations thereof to perform one or more of the method steps and/or functions described herein. A server may be programmed or reprogrammed. A server may be programmed or reprogrammed using software instructions, algorithms, code, lookup tables, or models to execute analytics, detection, correlation, or interpretation functions according to these teachings. In some embodiments, a server may be updated over time as data is received from one or more models and/or detection devices to improve efficiency, accuracy, or performance, including through automated learning processes such as machine learning or deep learning and/or through manual updates performed by software engineers.

A server may be implemented as a physical computing device, a virtualized computing instance, a distributed computing system, or any combination thereof. In some embodiments, the server may include specialized processing hardware, such as a graphics processing unit (GPU), neural processing unit (NPU), or other accelerator, to support image processing, video processing, machine learning, or deep learning operations.

As used herein, a network may comprise one or more communication infrastructures and an arrangement of interconnected devices, such as servers, processors, or computing devices, that enable electronic communication and data transfer between two or more devices, servers, or systems. A network may be configured to allow the exchange or sharing of resources, including data, images, video feeds, files, models, analytics, and/or other information. Communication within the network, or between networks, may occur via wired communication links, wireless communication links, or combinations thereof, and may utilize one or more communication protocols.

Information may be shared or transferred between or amongst devices or servers physically, such as using cables or portable storage media (e.g., USB drives), and/or wirelessly using available wireless technologies (e.g., Wi-Fi, Bluetooth, or other wireless standards). Networks may be configured as local networks, private networks, isolated networks, surveillance networks, property networks, cloud networks, or interconnected networks, and may include access control mechanisms that restrict or permit communication between devices or between networks. In some embodiments, a network may support unidirectional or bidirectional communication, may be segmented into sub-networks, and may be configured to limit access to data or devices connected thereto in accordance with security, regulatory, or operational requirements.

As used herein, to build or create a model, one or more images or electronic representations of one or more casino gaming tables and/or elements may be generated, created and/or acquired. One or more servers (e.g., a cloud server, property server, overhead detection server, table computer or processor, etc.) may include one or more processors and/or graphics processing units (GPU’s) that are configured to generate, train, build, and/or update a model.

Images or electronic representations of the one or more gaming elements may be transmitted to or retrieved by a server for use in building or updating the model, and/or a completed model may be transmitted to one or more servers for storage and/or deployment, including to a property server, overhead detection server, table computer or processor, or combinations thereof.

The images or electronic representations of the one or more gaming elements may be created, for example, by scanning one or more of the gaming elements with a camera or other scanning device. The scans may be a 2D or 3D representation. The images or electronic representations (e.g., CAD or other build files) may be obtained from a casino, table manufacturer, or vendor.

The images or electronic representations can be sent to or retrieved by a server for use in building the model and/or a completed model may be transmitted to one or more servers for storage and/or deployment, including to a property server, overhead detection server, table computer or processor, or combinations thereof.

In some configurations, a preliminary or generic model may be built and/or stored in one or more of the servers disclosed herein. A preliminary or generic model may be a model of one or more of the elements associated with the casino or gaming table but does not include the actual table layout. For example, a preliminary or generic model may include an electronic depiction or representation of one or more elements that typically do not change frequently, such as the playing cards, the gaming chips, the chip tray, the discard rack, the cut card, etc.

One or more gaming tables having different layouts may utilize a preliminary or generic model. This may advantageously speed up the process of building a model in that only data of a table layout needs to be produced and/or obtained from the vendor or manufacturer of the table layout when a new layout is to be used. This new table layout may then be combined or merged with the existing electronic depictions or representations of the gaming elements that did not change. This may save time and/or processing power to complete a model when a majority of the table elements are generic or already known and do not change.

In other embodiments, a preliminary or generic model may include a table layout and only an updated table element is added, such as if a casino includes a new gaming chip, playing card, etc., as may be the case for a special or promotional event for example, and the model may be updated accordingly.

A model may be created, trained, built, uploaded, and/or stored on one or more servers or networks. For example, a model may be built or created and stored on a cloud server, a property server, an overhead detection server, a table computer or processor, or another server. The model may be built or created on another server, and then uploaded or sent to a cloud server, property server, table computer or processor, overhead detection server, or any combination thereof. The model may be built or created on a server and not sent or transferred to any other server. For example, the model may be built or uploaded to the cloud server or premise sever or overhead detection server and operate on the cloud or premise or overhead detection server without being transferred to another server. The model may be transferred or sent to or between other servers via electronic communication of the networks on which the particular server(s) is located.

Model data in the model may contain information regarding game type, number of bet positions, identifiers and locations of additional wagers on the gaming table, commonly referred to as side wagers. After the model is received from the cloud server, metadata associated with the model, such as imagery of the layout, as well as information related to the number and type of wagering positions, can be added and stored on the property server. The property server may also verify an integrity of the model and ensure the model is complete (e.g., that all elements of the model are present and in good working order and not corrupt, for example).

After the model is located and available on the property server, the method may include a step of transmitting, communicating, or sending the model from the property server on the property network to the overhead detection server located on the surveillance network 108 at the casino facility. The model may be transmitted to the overhead detection server located on the surveillance network via a secured connection or transferred via a USB or other physical drive to the overhead detection server on the surveillance network.

In an embodiment, in or during operation of the system and method, one or more models are delivered to, or reside on, a casino on-property network (e.g., a property network) that is separate and distinct from a surveillance network. One or more selected models may be transferred, automatically or manually, into the surveillance network and installed on an analysis server on the surveillance network that has access to one or more camera feeds from one or more surveillance detection devices that are part of a casino surveillance or security system and are located on a surveillance network. The analysis server is configured to execute the model (e.g., the machine learning model and/or the deep-learning model) on live or near-live video streams from the one or more detection devices and generate model output data. An example of model output date is the presence of a chip at a particular wager position, a detected card value at a given location, or identification of a player at a specific seat. The resulting model output data is then transmitted from the analysis server on the surveillance network to the property server. The property server may include an interpretation engine, which interprets the output data to infer higher-level game events and performance metrics such as a gaming event or round has started or ended, bet wager amounts or information, hands per hour, player betting behavior, etc., thereby generating analytics related to the casino gaming activity taking place or has taken place. After the analytics are generated on the property network, the property server provides the analytics to casino operations, management, and/or other authorized casino personnel for monitoring, analysis, and operational decision-making.

In an embodiment, in or during operation of the system and method, one or more models are delivered to or reside on a casino on-property network (e.g., a property network) that is separate and distinct from a surveillance network. One or more image or video camera feeds from one or more detection devices on a surveillance network are transmitted to the property network. An analysis server on the property network is configured to execute the deep-learning model on live or near-live video streams from the one or more detection devices and generate model output data. An example of model output data is the presence of a chip at a particular wager position, a detected card value at a given location, or identification of a player at a specific seat. The resulting model output data generated by the analysis server on the property network is then provided to an interpretation engine on the property network, which interprets the output data to infer higher-level game events and performance metrics such as a gaming event or round has started or ended, bet wager amounts or information, hands per hour, player betting behavior, etc., thereby generating analytics related to the casino gaming activity taking place or has taken place.

The system and/or method may have or employ more than one model. For example, one model (a first model) may reside on the overhead detection server and configured to analyze or correlate camera images/video data of one or more elements such as card values, suites, currency values, etc. Another model (a second model) may reside on the table or premise sever and configured to analyze or correlate camera images/video data of a player’s face, chip values or chip stacks, etc.

In some embodiments, the method includes obtaining or generating a plurality of models associated with different gaming elements at a gaming table. A first model may comprise an electronic representation of one or more playing cards, including card values and suits, for use at the gaming table, and a second model may comprise an electronic representation of one or more gaming chips, including chip denominations and stack configurations, for use at the gaming table. The first model may be transmitted from a network, such as a cloud network or a property network, to a surveillance network, where the first model is made available to an overhead detection server that receives data generated by one or more overhead surveillance detection devices. Data obtained from the one or more overhead surveillance detection devices can be compared with the first model at the surveillance network to identify or correlate playing card information. The second model may be transmitted from a network, such as the cloud network, to the property network, where the second model is made available to a table network or table computer or processor or property server. Data obtained from one or more detection devices located at or near the gaming table, which may include table-mounted cameras, is compared with the second model to identify or correlate gaming chip information. The compared or correlated data derived at the surveillance network and the compared or correlated data derived at the property network may be interpreted by an interpretation engine executing on the property server or table computer or processor or elsewhere to generate analytics relating to the casino gaming activity.

This analyzed data from the one or more models can be provided or fed into one or more interpretation engines for interpreting or determining the game play activity or operational events that are or are not taking place. Such multi-model configuration may be applied or implemented in the embodiment illustrated and described at FIG. 7.

In some configurations, multiple models may reside on and/or be executed by a single server. For example, different gaming tables may have different table layouts, and corresponding models may be created for and associated with each layout. The teachings herein allow to run different models on the same or various servers depending on the situation.

In some configurations, one or more models may be transmitted from the cloud server on the cloud network to the overhead detection server on the surveillance network. In such configurations, communication may be 1-way or unidirectional, such that the overhead detection server and/or the surveillance network is configured to receive model data from the cloud server or cloud network without transmitting data back. This arrangement may help preserve the integrity and security of the surveillance network by reducing the risk of unauthorized data transfer from the surveillance network to external networks or servers.

As used herein, an interpretation engine may comprise one or more software modules, algorithms, rule sets, or executable instructions configured to receive data or model output data, and interpret such data to determine casino gaming activity and generate analytics. The interpretation engine may execute on one or more servers, such as a property server, table computer or processor, cloud server, or overhead detection server, and may utilize one or more processors and memories of the server on which it resides.

The interpretation engine may be configured to analyze the data or model output data received from one or more analysis servers and/or detection devices to identify, infer, or determine one or more game states, events, or conditions, including but not limited to a start of a game round, an end of a game round, wager placement, wager resolution, dealer activity, player activity, table utilization, or idle states. In some embodiments, the interpretation engine applies logical rules, heuristics, thresholds, or temporal relationships between detected events in the model output data to derive the analytics.

In some configurations, the interpretation engine may further incorporate or interact with one or more machine learning models or deep learning models to improve accuracy, robustness, or adaptability of the analytics. For example, the interpretation engine may process outputs generated by object recognition models identifying playing cards, gaming chips, betting regions, currency, or player actions, and may correlate such outputs over time to determine casino gaming activity.

In certain embodiments, the interpretation engine resides on a property network that is separate from a surveillance network, and receives only data or model output data transmitted from the surveillance network without receiving raw image or video data. This configuration enables generation of analytics while preserving security, regulatory compliance, and isolation of surveillance systems, and prevents unauthorized access to surveillance imagery.

The interpretation engine may output the generated analytics to casino operations systems, reporting systems, player rating systems, management interfaces, or other authorized systems or personnel. The interpretation engine may be updated, configured, or retrained over time to accommodate new table layouts, game rules, models, or operational requirements.

As used herein, analytics may include game play and round level analytics. Such analytics may include: start of a game round, end of a game round, number of rounds per unit time (minute/hour/shift/day), game state transitions (idle → active → payout → reset), detection of incomplete or aborted rounds, time duration of each round, or any combination thereof.

As used herein, analytics may include dealer performance and operational metrics. Such analytics may include: number of hands dealt per hour / shift / day, dealer efficiency metrics (hands per minute), dealer idle time, dealer changeover events, side wager promotion ability, dealer error rate, dealer card placement, dealer card exposure, customer service feedback, dealer break start and end times, duration since the last time dealing a game, shuffling skill, compliance with dealing procedures, detection of irregular dealer actions, or any combination thereof.

As used herein, analytics may include table utilization analytics. Such analytics may include table uptime (open and available for play), table downtime (closed, idle, or unavailable), time between rounds, peak utilization periods, underutilized tables, table availability across shifts, or a combination thereof.

As used herein, analytics may include player betting and wager analytics. Such analytics may include bet placement events, bet timing relative to game state, bet amount per wager, average bet per round, total wagered amount per session, win/loss per round, win/loss per hour, shift, or day, betting trends over time, identification of side wagers placed, identification of betting regions used, or a combination thereof.

As used herein, analytics may include chip, card, and/or currency analytics. Such analytics may include chip denomination identification, chip stack height and value estimation, total chips wagered per betting region, currency value detection during buy-in or cash-out, card value identification, card suit identification, card placement relative to betting regions, detection of card removal from the table, detection of shoe depletion or reshuffle events, or any combination thereof.

As used herein, analytics may include player identification and rating analytics. Such analytics may include player presence at a table, player arrival and departure times, player session duration, player betting profile, player average wager, player volatility (bet variation), player rating metrics, integration data for loyalty or player rating systems, or a combination thereof.

As used herein, analytics may include surveillance, security and compliance analytics. Such analytics may include detection of anomalous gameplay behavior, detection of irregular betting patterns, detection of unusual chip movement, detection of potential advantage play indicators, detection of rule violations, detection of suspicious dealer-player interactions, audit logs of gameplay activity, regulatory compliance metrics.

As used herein, analytics may include any information derived from monitored casino gaming activity that is useful for operational analysis, security, regulatory compliance, player rating, or business decision-making.

The analytics may include information relating to player betting behavior, which may be used in connection with a player rating system. In some embodiments, the analytics system and/or method according to these teachings may be incorporated into an existing player rating system or implemented as part of a new player rating system for a casino.

The analytics system and/or method of these teachings may further be used to evaluate and/or understand utilization of gaming tables, including periods during which a gaming table is operational or non-operational, and to generate performance metrics, such as a number of hands dealt by a dealer over a defined time period or dealer activity patterns during a shift, number of breaks a dealer takes during a shift, etc.

In some embodiments, the analytics system and/or method may implement chip recognition (e.g., identification of gaming chip denominations using one or more detection devices), currency detection (e.g., identification of currency values during buy-in and/or betting), and/or player identification techniques, such as facial or body recognition or other identification approaches, subject to applicable regulatory and operational requirements.

As used herein, machine learning refers to a class of computational techniques in which a system is configured to learn patterns, relationships, or representations from data and to improve performance on a task without being explicitly programmed for every possible scenario. A machine learning model may be trained using labeled data, unlabeled data, or a combination thereof, and may include supervised learning, unsupervised learning, semi-supervised learning, or reinforcement learning techniques. Machine learning models may be configured to perform tasks such as classification, detection, recognition, prediction, correlation, or decision making based on input data.

In the context of the systems and methods described herein, machine learning may be used to process data obtained from one or more detection devices to identify or recognize objects, patterns, or events associated with casino gaming activity, including playing cards, card values or suits, gaming chips, chip denominations or stacks, currency, betting regions, dealer actions, player actions, or game states. A machine learning model may be trained using historical data, reference imagery, simulated data, or live data collected from gaming environments, and may be updated or retrained over time to improve accuracy, robustness, or adaptability to new table layouts, gaming elements, or operational conditions.

As used herein, deep learning refers to a subset of machine learning techniques that utilize multi-layered computational models, such as neural networks, to learn hierarchical representations of data. A deep learning model may include one or more layers of interconnected nodes configured to extract increasingly abstract features from input data, such as image data, video data, or other sensor data. Deep learning models may be trained using labeled training data, unlabeled data, or combinations thereof, and may employ techniques such as convolutional neural networks, recurrent neural networks, transformer architectures, or other neural network architectures. In the systems and methods described herein, deep learning may be employed to analyze data obtained from one or more detection devices to identify, classify, or recognize elements associated with casino gaming activity, including but not limited to playing cards, card values or suits, gaming chips, chip denominations or stacks, currency, betting regions, dealer actions, player actions, or game states. Deep learning models may be trained using reference imagery, historical gameplay data, simulated data, or live data collected from casino environments, and may be updated or retrained over time to improve accuracy, resilience to environmental variation, and adaptability to different table layouts, gaming elements, or camera viewpoints.

The method disclosed herein may be used to monitor, understand, predict, review, analyze, decipher, observe, and/or evaluate operations and/or game play at one or more casino gaming tables. The method may provide insights or generate analytics relating to player betting behavior, utilization of gaming tables, and/or casino performance metrics, including, for example, the number of hands dealt by a dealer over a defined time period, timing and duration of dealer or employee breaks, table uptime during which a gaming table is open and available for game play, and table downtime during which the gaming table is closed or unavailable for game play.

The method may include one or more recognition components, such as chip recognition (e.g., identifying gaming chip denominations using one or more detection devices), card recognition (e.g., identifying a value and suit of a playing card and determining placement of the playing card relative to regions of interest on the gaming table), bet placement recognition (e.g., determining whether, when, and in what amount a wager is placed in a betting region during gameplay), and/or player identification techniques.

In some embodiments, player identification techniques may include facial recognition or other body identification approaches for identifying a player and/or detecting potentially unauthorized or anomalous activity, subject to applicable regulatory and operational constraints.

The analytics system 100 and/or method may include machine learning and/or deep learning capabilities. For example, a machine learning and/or deep learning model may be trained to learn or recognize relative dimensions, shapes, and visual patterns of gaming elements, such as playing cards or gaming chips, as viewed from different perspectives, including a top-down view captured by an overhead detection device and a side view captured by a detection device positioned at or near the gaming table. Such analysis may enable automated generation of information that has traditionally been recorded manually by casino staff or operators. The machine learning and/or deep learning models may be implemented on one or more of the servers or networks described herein, including, for example, a cloud server, a property server, a table computer or processor, an overhead detection server, or any combination thereof.

Improvements to the system and/or method may be needed from time to time. In addition, new elements might be requested in the model. In this instance, reference imagery would be acquired at the casino level and sent via an electronic method or delivered via a portable storage medium. Once received, a new model is created with the reference imagery and transferred as described herein.

The system and/or method may function with a cloud server or via a method, in which the files are input into the system via digital transmission with a manual input of the file into the property server or analysis server.

In another embodiment, all imagery, casino specific, and casino non-specific, might be stored on the property server or analysis server. If a new table layout is intended to be used, the casino staff would input the imagery for the layout into the property server or analysis server.

In some configurations: only inferred game-state information is transmitted from the surveillance network to the property network, and raw image or video data is not transmitted; the analytics include determining at least one game state selected from: start of a round, end of a round, payout event, dealer change, or table idle state; the surveillance network is isolated from external networks and prevents outbound transmission of player-visible gameplay information; the analytics are provided to a player rating or loyalty management system; the machine learning model outputs a confidence score associated with detected gaming activity.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. . A method for managing yield at a casino gaming table, comprising:
obtaining sensor-derived data associated with gameplay at the casino gaming table;
processing the sensor-derived data using one or more processors to generate inferred gameplay information representative of gaming objects, gameplay activity, or gameplay events;
providing the inferred gameplay information to one or more computing devices configured to manage operation of the casino gaming table;
obtaining, by the one or more computing devices, additional data associated with at least one of a casino, one or more players, or gameplay at the casino gaming table;
analyzing, using one or more processors, the inferred gameplay information together with the additional data to generate one or more outputs indicative of yield or operational performance of the casino gaming table; and
automatically performing, based on the one or more outputs, one or more yield-altering operational actions that modify operation of the casino gaming table.

2. . A method for managing yield at a casino gaming table, comprising:
analyzing, on a surveillance network that is isolated from a property network and that includes one or more detection devices, camera data generated by the one or more detection devices by executing at least one machine-learning or deep-learning model on the surveillance network to generate model output data representative of detected gaming objects, gameplay activity, and gameplay events, without transmitting raw camera images or video frames outside the surveillance network;
transmitting the model output data from the surveillance network to the property network at the casino, the property network being separate from the surveillance network;
obtaining, by one or more computing devices on the property network:
(i) casino-related data associated with the casino or gaming venue,
(ii) player-related data associated with one or more players playing at the gaming table or a gaming device, and/or
(iii) gameplay-related data associated with gameplay at the gaming table;
determining or obtaining, by the one or more computing devices, an optimal game pace for the gaming table based at least in part on a number of players playing at the gaming table;
analyzing, using one or more processors to execute one or more algorithms on the property network, the model output data together with one or more of the casino-related data, the player-related data, the gameplay-related data, and the optimal game pace to generate one or more outputs indicative of yield or operational performance of the gaming table; and
automatically performing, based on the one or more outputs, one or more yield-altering operational actions that modify operation of the gaming table, without requesting human approval or generating a recommendation.

3. . The method of claim 2, wherein the model output data excludes raw camera images or video frames, and wherein the one or more yield-altering operational actions are executed automatically without requiring human approval, wherein the one or more yield-altering operational actions comprise automatically increasing or decreasing a minimum betting limit at the gaming table or closing the gaming table from further game play.

4. . The method of claim 2, wherein the method comprises updating the at least one machine-learning or deep-learning model based on measured performance outcomes of the one or more yield-altering operational actions that were implemented without receiving a veto input that overrides implementation of the one or more yield-altering operational actions.

5. . The method of claim 3, wherein the one or more yield-altering operational actions comprise assigning a new dealer to the gaming table.

6. . The method of claim 3, wherein performing the one or more yield-altering operational actions comprises providing notice of an automatic or pending operational change to one or more players via a player-facing screen or player notification device, the player-facing screen or player notification device comprising a player-facing table display or screen.

7. . The method of claim 6, further comprising receiving a veto input to override implementation of the one or more yield-altering operational actions, wherein the veto input requires a user to enter a reason for the veto, and wherein the entered reason is stored and used to train or update one or more processors or models used to generate subsequent automated operational changes associated with the gaming table.

8. . The method of claim 2, wherein performing the one or more yield-altering operational actions is subject to a pre-approved rules engine configured in advance to define permissible operational changes and constraints under which the one or more yield-altering operational actions may be executed, the pre-approved rules engine operating as a compliance constraint and not as a real-time decision-making or approval component.

9. . The method of claim 8, wherein the pre-approved rules engine defines different permissible operational changes based on at least one of a jurisdiction, game type, gaming table, time period, or regulatory requirement.

10. . The method of claim 2, wherein the casino-related data includes operating hours, staffing information, special event information, or patron traffic information.

11. . The method of claim 2, wherein the player-related data includes wagering behavior, loyalty tier information, bankroll-related information, visit frequency, or decision-speed information.

12. . The method of claim 2, wherein the gameplay-related data includes betting limits, hands dealt per unit time, dealer performance information, or gameplay discrepancy information.

13. . The method of claim 2, wherein determining or obtaining the optimal game pace comprises calculating the optimal game pace using one or more algorithms executed by the one or more processors.

14. . The method of claim 2, wherein determining or obtaining the optimal game pace comprises retrieving the optimal game pace from a memory, database, or look-up table.

15. . The method of claim 2, further comprising evaluating an outcome of the one or more yield-altering operational actions by comparing a predicted yield to an actual yield after the operational action is implemented.

16. . The method of claim 2, wherein the analysis is performed using a machine-learning or deep-learning model that is updated based on feedback derived from the evaluated outcome.

17. . A system for managing yield relating to casino gaming activity at a gaming table in a casino, the system comprising:
a first network comprising one or more detection devices configured to generate camera data of the gaming table;
one or more first computing devices operatively connected to or executed on the first network and configured to execute at least one model on the camera data to generate model output data representative of detected gaming objects, gameplay activity, and/or inferred gameplay events associated with the casino gaming activity;
a second network at the casino that is separate from the first network;
a communication interface configured to transmit the model output data, and not the camera data, from the first network to the second network;
one or more second computing devices operatively connected to the second network and configured to:
obtain casino-related data associated with the casino or gaming venue,
obtain player-related data associated with one or more players playing at the gaming table or a gaming device,
obtain gameplay-related data associated with gameplay at the gaming table,
determine or obtain an optimal game pace for the gaming table based at least in part on a number of players playing at the gaming table,
analyze, using one or more processors executing one or more algorithms, the model output data together with one or more of the casino-related data, the player-related data, the gameplay-related data, and the optimal game pace to generate one or more outputs indicative of yield or operational performance of the gaming table; and
in response to the one or more outputs, perform one or more operational actions associated with operation of the gaming table.

18. . The method of claim 17, wherein the one or more yield-altering operational actions comprise automatically increasing or decreasing a minimum betting limit at the gaming table or closing the gaming table from further game play.

19. . The method of claim 18, wherein performing the one or more yield-altering operational actions comprises providing notice of an automatic or pending operational change to one or more players via a player-facing screen or player notification device, the player-facing screen or player notification device comprising a player-facing table display or screen.

20. . The method of claim 19, further comprising receiving a veto input to override the automatic or pending operational change, wherein the veto input requires a user to enter a reason for the veto, and wherein the entered reason is stored and used to train or update one or more processors or models used to generate subsequent automated operational changes associated with the gaming table.
